(19) United States
(12) Patent Application Publication
(10) Pub. No.: US 2026/0300819 A1
(43) Pub. Date: Oct. 1, 2026

(54) GENERATIVE MACHINE LEARNING MODEL TRAINING SYSTEM

(71) Applicant: Amazon Technologies, Inc., Seattle, WA (US)

(72) Inventors: Fei Wu, Dublin, CA (US); Arun Babu Nagarajan, Redmond, WA (US); Leonard Elias Lausen, Hoboken, NJ (US); Anirudh Viswanathan, Santa Clara, CA (US); Haohan Chen, Belmont, CA (US); Teng Xu, Santa Clara, CA (US); Zachary Kimberg, Mountain View, CA (US); Chang Ning Tsai, Mountain View, CA (US); Ankur Mehrotra, Sammamish, WA (US); Sudipta Sengupta, Bellevue, WA (US)

(73) Assignee: Amazon Technologies, Inc., Seattle, WA (US)

(21) Appl. No.: 19/096,475

(22) Filed: Mar. 31, 2025

(51) Int. Cl. G06N 20/00; G06F 11/3604

(52) U.S. Cl. CPC G06N 20/00; G06F 11/3612

(57) ABSTRACT

A generative machine learning model training system manages distributed training processes across a cluster of nodes, wherein each node executes tasks corresponding to discrete cycles of a training loop. Each cycle comprises a first phase including a forward pass, backward pass, and gradient averaging and a second phase that updates optimizer states and model weights based on the averaged gradients. Subsequent to detecting a fault occurring during the second phase at a given node, the generative machine learning model training system allows the healthy nodes to complete the second phase using gradients previously averaged during the first phase. The generative machine learning model training system sends updated optimizer states and model weights from a healthy node to initialize a standby node and proceed to perform another cycle using the standby node and the healthy nodes.

### BACKGROUND

Large language models (LLMs) are advanced machine learning models designed to understand and generate human language. LLMs may be employed across various scenarios requiring language comprehension. For example, LLMs may be utilized in natural language processing (NLP) applications such as chatbots, content generation, and language translation, wherein LLMs may be required to interpret and produce text responses across diverse contexts. Given the broad spectrum of subject matters, LLMs are trained on large datasets encompassing different domains in order to ensure that the LLMs may be able to handle a wide variety of tasks, such as generating coherent and contextually appropriate answers to queries provided by a user.

### BRIEF DESCRIPTION OF THE DRAWINGS

FIG. 1A is a block diagram illustrating a generative machine learning model training system that, in response to a determination that a fault has occurred during a second phase of a cycle of a training loop on a given node, continues to complete the second phase on other nodes of a node cluster that are healthy nodes, according to some embodiments.

FIG. 1B is a block diagram illustrating a generative machine learning model training system that sends, from a selected one of healthy nodes to a standby node, an updated optimizer state and updated model weights, according to some embodiments.

FIG. 2A illustrates a more detailed view of a generative machine learning model training system that, in response to detecting that a fault has occurred during a first phase, sends, from a selected one of nodes of a node cluster that remain healthy to a standby node, a current optimizer state and current weights for a given generative machine learning model, according to some embodiments.

FIG. 2B illustrates a more detailed view of a generative machine learning model training system that, in response to detecting that the other fault has occurred during a first phase, restarts the first phase on healthy nodes, according to some embodiments.

FIG. 3 illustrates a more detailed view of a generative machine learning model training system that, in response to detecting that a fault has occurred during a cycle at a node of a node cluster, reset respective nodes of the node cluster, including a faulty node, using a previously saved training checkpoint, according to some embodiments.

FIG. 4 illustrates a more detailed view of a generative machine learning model training system that generates, using respective process-level agents at the cluster of nodes, process-level heartbeats, wherein the respective process-level agents generate the process-level heartbeats at a heartbeat frequency, according to some embodiments.

FIG. 5 illustrates a flowchart of operations that sends, from a selected one of healthy nodes to a standby node, an updated optimizer state and updated model weights, according to some embodiments.

FIG. 6 illustrates a flowchart of operations performed by a generative machine learning model training system to send, in response to detecting that another fault has occurred during a first phase on another node of a node cluster, a current optimizer state and current weights for a given generative machine learning model to a standby node, according to some embodiments.

FIG. 7 illustrates a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (e.g., meaning having the potential to), rather than the mandatory sense (e.g., meaning must). Similarly, the words “include,” “including,” and “includes” mean including, but not limited to.

### DETAILED DESCRIPTION OF EMBODIMENTS

The systems and methods described herein include techniques for implementing a generative machine learning model training system configured to manage fault-tolerant execution of distributed training jobs across a node cluster. The generative machine learning model training system trains a generative machine learning model using multiple training processes executed by respective nodes within the cluster. Each node conducts training processes associated with distinct cycles of a training loop, wherein each cycle comprises a first phase and a second phase. The first phase includes performing a forward pass, performing a backward pass, and averaging gradients across the node cluster. The second phase comprises updating optimizer states using the averaged gradients and subsequently updating the weights of the generative machine learning model based on these updated optimizer states. The generative machine learning model training system monitors training processes at the process level and detects faults occurring within the training processes executed on any given node, including determining whether the fault occurred during the first phase or the second phase. Upon detecting that a fault has occurred during the second phase, the generative machine learning model training system allows healthy nodes within the cluster to continue and complete the second phase, including updating optimizer states and model weights. In completing the second phase, the healthy nodes utilize the averaged gradients determined during the first phase, incorporating gradients computed by the faulty node prior to failure at the second phase. After completion of the second phase, the updated optimizer states and model weights from a selected healthy node are communicated to a standby node, which replaces the faulty node. The generative machine learning model training system continues the training process without requiring external checkpoints and/or unnecessary termination of unaffected nodes.

At least one difficulty in managing large-scale distributed training workloads involves effectively addressing the increasing frequency of faults and the subsequent degradation in resilience performance, typically measured by metrics such as “goodput”. For example, conventional checkpoint-based fault recovery approaches may commonly incur non-trivial overhead as the scale of a cluster grows, primarily due to the frequent saving and loading of large checkpoint files across numerous nodes. Such overhead results in prolonged recovery times and negatively impacting overall training efficiency. Furthermore, typical fault-tolerance designs for generative machine learning model training rely on optimistic assumptions about fault occurrences scaling linearly with cluster size (as well as consistent recovery durations across various scales). However, at larger scales, these assumptions may often fail to hold, leading to unpredictable increases in downtime and disruptions. Additionally, traditional recovery methods may frequently trigger restarts at job or node-group levels even when faults affect only a subset of processes, which unnecessarily terminates healthy execution environments and wastes computational resources. Such checkpoint-induced overhead, unrealistic fault-scaling assumptions, and excessive restart granularity may contribute to substantial inefficiencies in existing fault-recovery mechanisms for distributed training of large-scale generative machine learning models.

In some embodiments, a generative machine learning model training system may manage fault-tolerant execution of distributed training jobs for generative machine learning models across a cluster of nodes, where each node executes training processes associated with a training job. The training processes performed by each node may be structured into discrete cycles of a training loop, wherein each cycle comprises a first phase and a second phase. Specifically, the first phase may include performing a forward pass through the model, performing a backward pass to compute gradients, and averaging gradients across all nodes in the cluster. The second phase may involve updating optimizer states using these averaged gradients, and subsequently applying these updated optimizer states to modify the model weights. The generative machine learning model training system may utilize process-level agents deployed on each node to continuously monitor the health and operational status of training processes. For example, these agents may track metrics such as computational throughput, resource usage, communication status, and error conditions to quickly identify emerging faults. Based on such granular monitoring data, the system may detect when a fault occurs within the training processes executing on any particular node, including determining precisely whether such a fault occurred during the first phase or the second phase of the training loop cycle. Upon detecting a fault specifically during the second phase (e.g., an abrupt termination of an optimizer update process on a given node) the generative machine learning model training system may allow healthy nodes within the node cluster to proceed uninterrupted and complete the ongoing second phase. In doing so, the healthy nodes may update their optimizer states and model weights using the averaged gradients computed during the preceding first phase, including gradients calculated by the faulty node before encountering the fault. After the successful completion of the second phase by these healthy nodes, the generative machine learning model training system may facilitate checkpoint-less recovery by transferring the updated optimizer states and model weights from one of the healthy nodes to a pre-provisioned standby node. For example, a standby node that was previously initialized with the appropriate pipeline and tensor parallel configurations may receive the model state and optimizer parameters via high-performance interconnects. Once synchronized, the standby node may replace the faulty node and integrate back into the ongoing distributed training loop without requiring external checkpoint restoration, job-level restarts, or unnecessary termination of unaffected nodes.

In some embodiments, subsequent to detecting another fault occurring during the first phase of a cycle of the training loop on a particular node within the node cluster, the generative machine learning model training system may initiate a targeted recovery procedure. In some embodiments, in response to detecting that such additional fault has occurred specifically during the first phase on the affected node, the generative machine learning model training system may restart the first phase of the current training loop cycle across the nodes within the node cluster that remain healthy. In some embodiments, restarting the first phase on these healthy nodes may ensure synchronization of model states and gradient computations across the entire node cluster. For example, restarting the first phase may involve performing the forward pass, backward pass, and subsequent gradient averaging operations again across the healthy nodes, thereby maintaining consistency of the averaged gradients used during optimizer state updates in the subsequent second phase.

In some embodiments, subsequent to detecting another fault occurring during the first phase of a cycle of the training loop on an affected node within the node cluster, the generative machine learning model training system may initiate a selective recovery procedure. In some embodiments, upon detecting that the additional fault specifically occurred during the first phase on the affected node, the generative machine learning model training system may permit the remaining healthy nodes within the node cluster to continue and complete the first phase of the ongoing cycle, including performing a forward pass, backward pass, and subsequent averaging of gradients. In some embodiments, once the first phase has been successfully completed by the healthy nodes, as well as by another standby node that replaces the affected node after receiving current optimizer states and model weights, the generative machine learning model training system may proceed to perform the second phase of the training loop cycle. For example, the generative machine learning model training system may utilize the averaged gradients computed during the completed first phase to update optimizer states and subsequently update model weights across the standby node and the healthy nodes.

In some embodiments, subsequent to detecting another fault occurring during another cycle of the training loop executed by the generative machine learning model training system, the generative machine learning model training system may initiate a recovery procedure utilizing an externally stored training checkpoint. In some embodiments, in response to detecting that such additional fault has occurred during the training loop cycle on another node within the node cluster, the generative machine learning model training system may reset one or more respective nodes of the node cluster, including the faulty node, using a previously saved training checkpoint. For example, the generative machine learning model training system may retrieve the externally stored training checkpoint, which may contain optimizer states, model weights, and other relevant training metadata, from a dedicated external checkpoint storage service or storage repository. In some embodiments, by resetting nodes of the node cluster to the consistent state captured in the previously saved training checkpoint, the generative machine learning model training system may ensure synchronization and correctness across all nodes, thereby addressing issues arising from inconsistent or divergent model states caused by the fault.

In some embodiments, in response to detecting a fault on a given node within the node cluster, the generative machine learning model training system may select a healthy node from which to source recovery data, including optimizer state and model weights. In some embodiments, the selected healthy node may be a data parallel peer of the faulty node, meaning it may hold an equivalent replica of the model and optimizer state corresponding to the same training job. In some embodiments, the selection of the healthy node may be based on the structural similarity between the healthy node and the faulty node with respect to the generative machine learning model architecture. For example, the generative machine learning model training system may identify a data parallel peer that maintains the same one or more layers of the generative machine learning model as the faulty node, or a peer that holds the same one or more tensors (such as weight matrices, embedding tables, or attention module parameters) assigned to the faulty node.

In some embodiments, in response to detecting a fault on a given node of the node cluster, the generative machine learning model training system may select a standby node from a plurality of pre-provisioned standby nodes to serve as a replacement for the faulty node. In some embodiments, the selection of the standby node may be based on one or more ranks assigned to one or more training processes of the training job previously performed on the given node. In some embodiments, the generative machine learning model training system may maintain a pool of standby nodes, wherein the pool comprises a standby node associated with a first rank, a standby node associated with a last rank, and a standby node associated with a middle rank situated between the first rank and the last rank. In some embodiments, the ranks may correspond to pipeline parallel stages of the generative machine learning model, with the first rank representing the initial stage of the model (e.g., embedding layers), the last rank representing the final stage of the model (e.g., output projection layers), and the middle rank representing one or more replicated intermediate layers (e.g., transformer blocks).

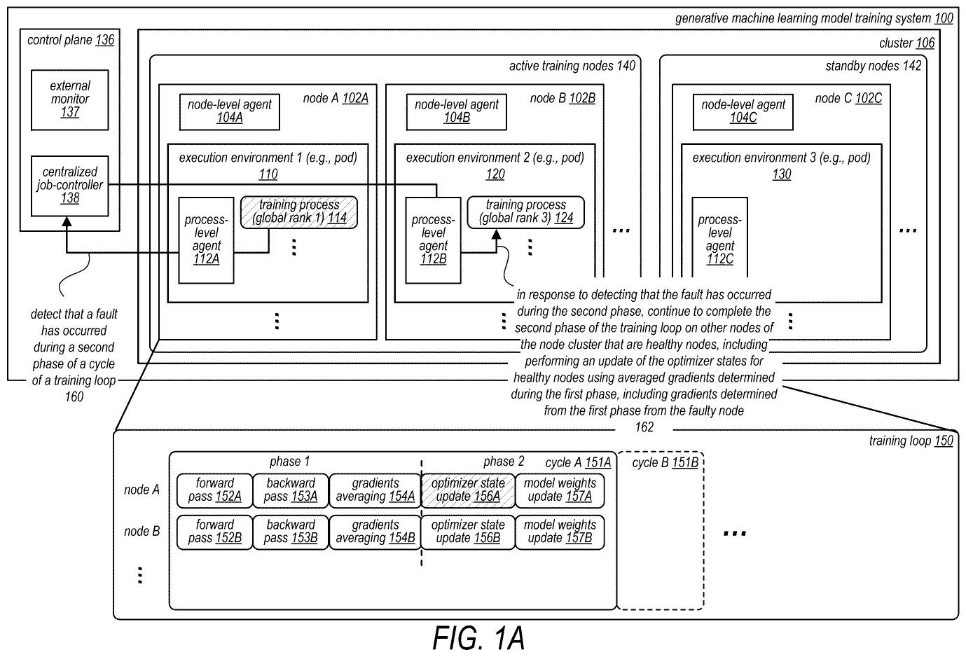

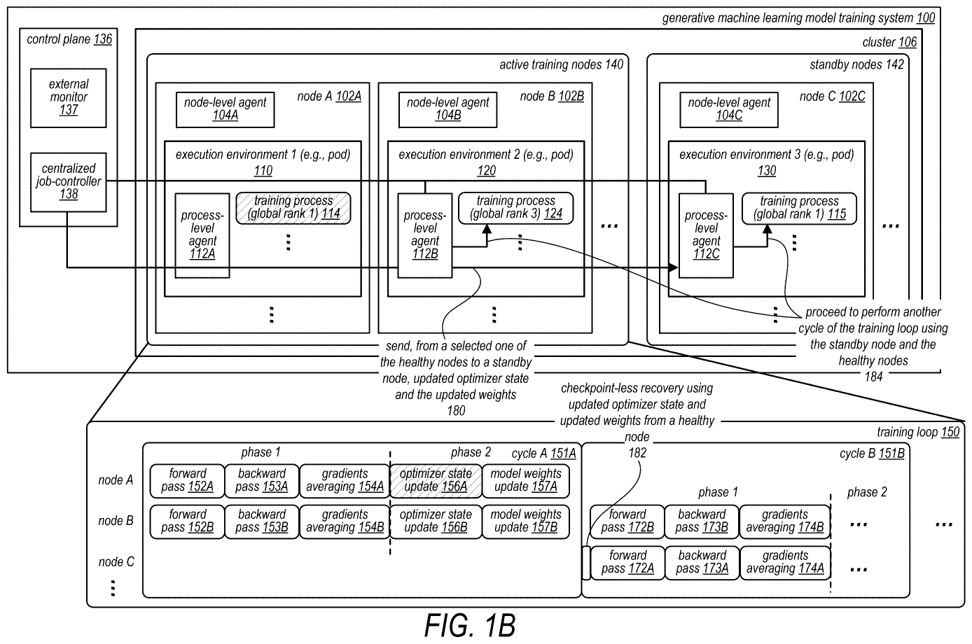

FIG. 1A is a block diagram illustrating a generative machine learning model training system that, in response to a determination that a fault has occurred during a second phase of a cycle of a training loop on a given node, continues to complete the second phase on other nodes of a node cluster that are healthy nodes, according to some embodiments.

In some embodiments, a generative machine learning model training system 100 may comprise a cluster 106 of nodes configured to collaboratively train a generative machine learning model. In some embodiments, the cluster 106 of nodes may include active training nodes 140, which may comprise node A 102A and node B 102B, each having respective node-level agents 104A and 104B configured to manage and monitor training processes occurring within the corresponding nodes. In some embodiments, each of the active training nodes 140, such as node A 102A and node B 102B, may comprise respective one or more execution environments used to execute training processes. For example, node A 102A may comprise an execution environment 1 (e.g., pod) 110, while node B 102B may comprise an execution environment 2 (e.g., pod) 120. In some embodiments, each execution environment may include a respective process-level agent responsible for managing one or more training processes executed within that execution environment. For example, execution environment 1 (e.g., pod) 110 on node A 102A may comprise a process-level agent 112A, and execution environment 2 (e.g., pod) 120 on node B 102B may comprise a process-level agent 112B. In some embodiments, these process-level agents 112A and 112B may be responsible for monitoring and managing specific training processes. For example, training process (global rank 1) 114 may execute within execution environment 1 (e.g., pod) 110 on node A 102A, and training process (global rank 2) 124 may execute within execution environment 2 (e.g., pod) 120 on node B 102B. In some embodiments, the cluster 106 may further include one or more standby nodes 142, such as node C 102C. In some embodiments, the standby nodes, including node C 102C, may be deployed and provisioned with execution environments in advance of fault occurrences to enable faster fault recovery. For example, node C 102C may already have an execution environment 4 (e.g., pod) 130 deployed and initialized prior to any faults detected in the active training nodes 140 (e.g., a process-level fault or a node-level fault). For example, in some embodiments, a process-level fault may comprise failures or interruptions occurring within individual training processes executed in specific execution environments, such as an unexpected termination or deadlock of a training process. In some embodiments, a node-level fault may involve a more extensive failure at the node level, affecting the execution environments and processes running on a given node. In some embodiments, pre-provisioning of execution environments on standby nodes may facilitate faster initialization and recovery of training processes by transferring model states, optimizer states, and other relevant data from healthy execution environments (e.g., pods). As illustrated in FIG. 1A, node A 102A and node B 102B may comprise replicated models, each maintaining identical model weights and optimizer states. For simplicity of illustration, only two nodes are depicted and model partitioning or sharding is not illustrated. However, in various embodiments, the replicated models A 102A and model B 102B may be sharded, with different nodes storing distinct partitions or shards of the generative machine learning model.

In some embodiments, the generative machine learning model training system 100 may comprise a control plane 136 that manages distributed training across the cluster of nodes. In some embodiments, the control plane 136 may comprise a centralized job controller 138 and an external monitor 137. In some embodiments, the centralized job controller 138 may manage the coordination, ranking, barrier synchronization, and restart training processes across execution environments within the cluster. In some embodiments, the external monitor 137 may detect training job faults originating from sources external to individual nodes or the cluster itself. For example, the external monitor 137 may detect faults by monitoring external node health indicators, such as cloud infrastructure-level alerts, instance retirement notices, or instance status impairments. In some embodiments, the external monitor 137 may monitor external sources such as instance heartbeat statuses, instance health status reports obtained from cloud provider APIs (e.g., using an instance status API call), or cloud-generated health events (e.g., retirement notices or maintenance alerts). In some embodiments, external monitor 137 may leverage faster mechanisms (e.g., node heartbeat monitoring) as a primary method of fault detection, with slower or delayed mechanisms (e.g., instance status API responses or cloud-provider health events) serving as secondary, backup mechanisms.

In some embodiments, respective node-level agents (e.g., node-level agent 104A, node-level agent 104B, etc.) may monitor node health during the training of the given generative machine learning model. In some embodiments, the node-level agents may monitor indicators of node-level health, including resource availability (e.g., CPU, GPU/accelerator, memory utilization), responsiveness, network connectivity, and the operational status of execution environments hosted on their respective nodes. In some embodiments, the node-level agents may generate node-level heartbeats or health status reports periodically and provide these reports to the centralized job controller 138. Based on node health status information from the node-level agents, the centralized job controller 138 may detect node-level faults and may perform recovery actions, such as replacing faulty nodes with standby nodes. In some embodiments, respective process-level agents (e.g., process-level agent 112A, process-level agent 112B, etc.) may monitor process health for the respective training processes executing within execution environments on their respective nodes. In some embodiments, each process-level agent may monitor health indicators specific to the training processes, such as process crashes, deadlocks, degraded computational performance, abnormal resource consumption, or unexpected termination. In some embodiments, the respective process-level agents may locally analyze logs, generate process-level heartbeats, or provide health indicators and health status information directly to the centralized job controller 138, thereby enabling faster detection of faults.

In some embodiments, the generative machine learning model training system 100 may train a given generative machine learning model using the node cluster 106, where the node cluster 106 may perform multiple training processes associated with a training job. In some embodiments, the training job performed by the generative machine learning model training system 100 may comprise executing a training loop 150. In some embodiments, the training loop 150 may comprise performing one or more cycles, such as cycle A 151A and cycle B 151B, wherein each cycle of the training loop 150 may include at least two distinct phases. In some embodiments, each cycle of the training loop 150 executed as part of the training job for a given generative machine learning model may include a first phase and a second phase. In some embodiments, the first phase of a cycle may comprise performing a forward pass, a backward pass, and an averaging of gradients across nodes within the node cluster 106. In some embodiments, the second phase may comprise updating optimizer states using the averaged gradients determined during the first phase, and subsequently updating weights of the given generative machine learning model using the updated optimizer states. For example, cycle A 151A may comprise performing a forward pass executed by node A 102A and node B 102B (e.g., forward pass 152A and forward pass 152B), performing a backward pass executed by node A 102A and node B 102B (e.g., backward pass 153A and backward pass 153B), and performing gradient averaging executed by node A 102A and node B 102B (e.g., gradient averaging operation 154A and gradient averaging operation 154B). In some embodiments, the forward pass during the first phase may involve propagating input data through the generative machine learning model to compute model outputs or activations, and the backward pass may involve computing gradients of the loss function with respect to model parameters. In some embodiments, subsequently, the gradients computed by individual nodes, such as node A 102A and node B 102B, may be aggregated and averaged across the entire node cluster 106 during the gradient averaging operation.

In some embodiments, the second phase of each cycle within the training loop 150 executed by the generative machine learning model training system 100 may comprise performing an update of an optimizer state using the averaged gradients computed during the first phase, and subsequently performing an update of weights for the given generative machine learning model using the updated optimizer state. For example, cycle A 151A may further comprise an optimizer state update operation performed independently by node A 102A and node B 102B (e.g., optimizer state update 156A executed by node A 102A, and optimizer state update 156B executed by node B 102B). In some embodiments, the optimizer state update operation may utilize the averaged gradients obtained during the gradient averaging operation performed by node A 102A and node B 102B. In some embodiments, subsequent to completing the optimizer state updates, cycle A 151A may further comprise performing an update of model weights independently on node A 102A and node B 102B, using the respective updated optimizer states (e.g., model weights update 157A executed by node A 102A, and model weights update 157B executed by node B 102B). In some embodiments, during the model weights update operation, the generative machine learning model training system 100 may adjust the parameters (weights) of the generative machine learning model to incorporate the optimizer state adjustments computed in the preceding optimizer state update operation.

In some embodiments, the centralized job-controller 138 of the generative machine learning model training system 100 may detect 160 that a fault has occurred during the second phase of a cycle of a training loop executed across the node cluster 106. In some embodiments, the centralized job-controller 138 may continuously or periodically receive health-status information from respective node-level agents (e.g., node-level agents 104A and 104B) and/or respective process-level agents (e.g., process-level agent 112A on node A 102A and process-level agent 112B on node B 102B). In some embodiments, the health-status information may include metrics indicative of the operational state of training processes, such as heartbeat signals, error logs, resource utilization metrics, computational throughput indicators, and/or communication status signals. In some embodiments, upon analyzing such health-status information, the centralized job-controller 138 may determine that a specific training process has encountered a fault during the second phase (such as during the optimizer state update 156A at the node A 102A) of the cycle A 151A within the training loop 150. For example, the centralized job-controller 138 may detect the absence of heartbeat signals from a training process (e.g., training process (global rank 1) 114 executing in execution environment 1 (e.g., pod) 110 on node A 102A), or it may receive explicit error notifications transmitted by a corresponding process-level agent (e.g., process-level agent 112A). In some embodiments, upon determining that a training process is no longer responsive or has otherwise failed during the second phase, the centralized job-controller 138 may initiate recovery actions, including transferring updated optimizer states and model weights from a healthy node to a designated standby node, as further discussed in FIG. 1B.

In some embodiments, in response to detecting that a fault has occurred during the second phase, the generative machine learning model training system 100 may continue to complete 162 the second phase of the training loop on other nodes of the node cluster 106 that are healthy nodes, including performing an update of the optimizer states for healthy nodes using averaged gradients determined during the first phase, using gradients determined from the first phase from the faulty node. For example, if node A 102A experiences a fault during its optimizer state update (e.g., optimizer state update 156A), the centralized job-controller 138 of the generative machine learning model training system 100 may permit the healthy node, such as node B 102B, to continue and complete its optimizer state update operation (e.g., optimizer state update 156B) using the averaged gradients without restarting the training process 124. In some embodiments, the averaged gradients used by node B 102B may already incorporate gradient information calculated by the faulty node (e.g., node A 102A) during the first phase prior to failure. In some embodiments, following completion of the optimizer state updates, healthy nodes, such as node B 102B, may subsequently proceed to update the model weights using their respective updated optimizer states (e.g., model weights update 157B). In some embodiments, upon successful completion of the second phase by the healthy nodes, the centralized job-controller 138 may initiate transfer of the updated optimizer states and model weights from a healthy node (e.g., node B 102B) to a pre-provisioned standby node (e.g., node C 102C), as further discussed in FIG. 1B.

FIG. 1B is a block diagram illustrating a generative machine learning model training system that sends, from a selected one of healthy nodes to a standby node, an updated optimizer state and updated model weights, according to some embodiments.

In some embodiments, a centralized job-controller 138 may send 180, from a selected one of the healthy nodes to a standby node, updated optimizer state and the updated weights. For example, subsequent to detecting and responding to a fault occurring during the second phase (e.g., optimizer state update 156A) of a cycle A 151A, the centralized job-controller 138 of a generative machine learning model training system 100 may select one of the healthy nodes within the node cluster 106 to serve as a source node for transmitting the updated optimizer state and updated model weights to a designated standby node. In some embodiments, the centralized job-controller 138 may instruct a selected healthy node, such as healthy node B 102B, to transmit its updated optimizer state and updated model weights to a standby node, such as a pre-provisioned node C 102C. For example, the centralized job-controller 138 may initiate a transfer operation 180 in which healthy node B 102B communicates its updated optimizer state and updated model weights (e.g., obtained at the conclusion of its optimizer state update operation 156B and model weights update operation 157B) to standby node C 102C. In some embodiments, such communication may utilize high-performance inter-node communication protocols, allowing standby node C 102C to receive and rehydrate its execution environment with these current and consistent states without relying upon externally stored checkpoints. In some embodiments, using the sent updated optimizer state and the updated weights, a cycle B 151B may comprise checkpoint-less recovery 182.

In some embodiments, a generative machine learning model training system 100 may proceed to perform 184 another cycle of the training loop using the standby node and the healthy nodes. For example, in some embodiments, following completion of a checkpoint-less recovery process, the generative machine learning model training system 100 may proceed to perform another cycle of the training loop utilizing the synchronized standby node and the healthy nodes within the node cluster 106. In some embodiments, the next cycle, such as cycle B 151B, may comprise multi-phase operations including a first phase comprising a forward pass, a backward pass, and gradient averaging across participating nodes as discussed. For example, cycle B 151B may comprise a forward pass operation performed by healthy node B 102B and recovered standby node C 102C (e.g., forward pass 172B performed by node B 102B and forward pass 172A performed by node C 102C). In some embodiments, these forward passes may utilize input data batches distinctively assigned to each participating node, propagating inputs through their respective copies of the generative machine learning model initialized with synchronized weights obtained during checkpoint-less recovery. In some embodiments, cycle B 151B may further include a backward pass operation performed independently by node B 102B and node C 102C (e.g., backward pass 173B performed by node B 102B and backward pass 173A performed by node C 102C). In some embodiments, during the backward pass, each node may compute local gradients of the loss function with respect to the model parameters. In some embodiments, subsequently, cycle B 151B may comprise gradient averaging performed by node B 102B and node C 102C (e.g., gradient averaging operation 174B and gradient averaging operation 174A, respectively), during which the gradients computed independently by the nodes may be aggregated and averaged to form a consistent set of gradients to be utilized for optimizer state updates in a subsequent phase.

In some embodiments, the generative machine learning model training system 100 may execute the training loop 150 using training processes associated with specific global ranks across respective execution environments within the node cluster 106, as part of performing training cycles such as cycle B 151B. For example, execution environment 2 (e.g., pod) 120 may continue to execute the same training process assigned global rank 3, identified as training process (global rank 3) 124 without restarting the process (e.g., using in-process restart), while execution environment 3 (e.g., pod) 130 may execute a training process assigned global rank 1, identified as training process (global rank 1) 115. In some embodiments, training process (global rank 3) 124 performed within execution environment 2 (120) and training process (global rank 1) 115 performed within execution environment 3 (130). In some embodiments, during cycle B 151B, both training processes (global rank 3) 124 and (global rank 1) 115 may independently perform training operations corresponding to different phases of the cycle, such as the forward pass, backward pass, gradient averaging, optimizer state update, and model weights update. In some embodiments, each training process may utilize a respective portion of input data batches to perform forward pass computations, generate activations, calculate gradients during the backward pass, and subsequently participate in gradient averaging across nodes within the node cluster 106. In some embodiments, during the second phase of cycle B 151B, training process (global rank 3) 124 executed within execution environment 2 (120) and training process (global rank 1) 115 executed within execution environment 3 (130) may utilize averaged gradients resulting from the first phase to independently update optimizer states and subsequently adjust model weights of the generative machine learning model.

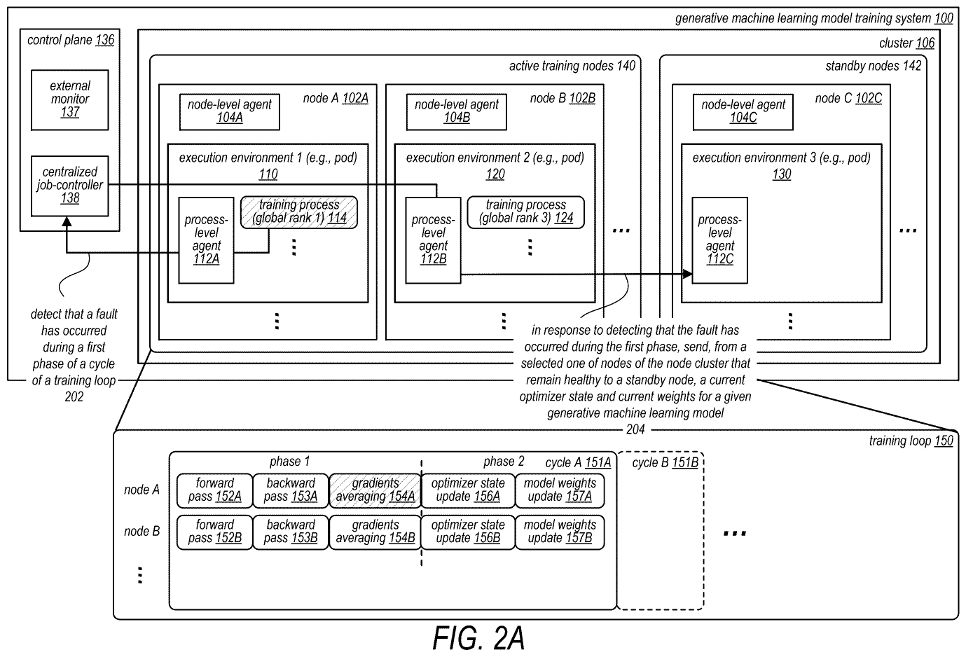

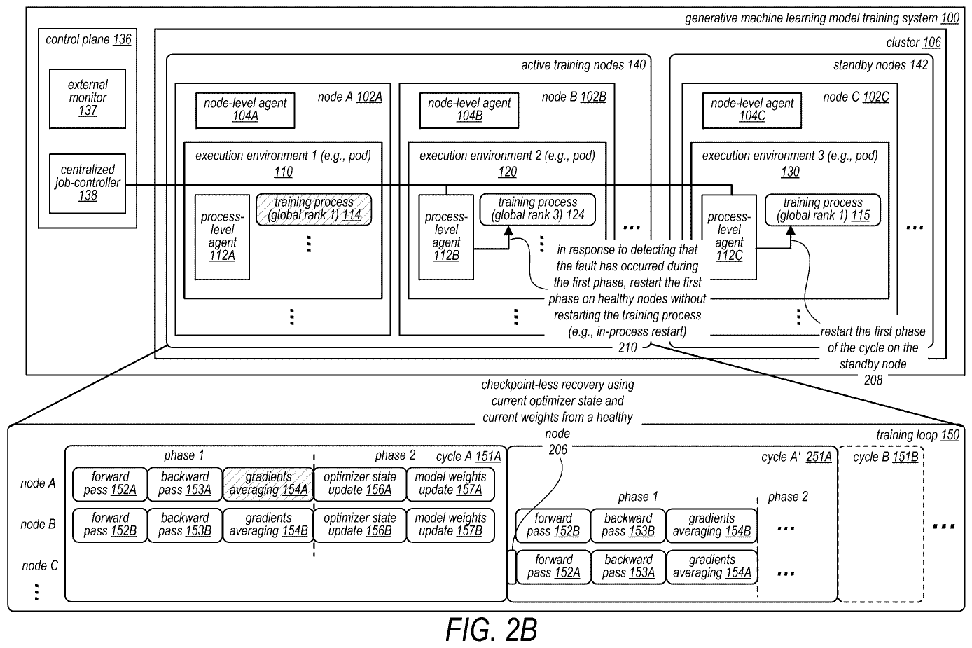

FIG. 2A illustrates a more detailed view of a generative machine learning model training system that, in response to detecting that a fault has occurred during a first phase, sends, from a selected one of nodes of a node cluster that remain healthy to a standby node, a current optimizer state and current weights for a given generative machine learning model, according to some embodiments.

In some embodiments, the centralized job-controller 138 of the generative machine learning model training system 100 may detect 202 that a fault has occurred during the first phase of a cycle within the training loop 150 executed across the node cluster 106. For example, the centralized job-controller 138 may detect that a fault has occurred specifically in a training process, such as training process (global rank 1) 114, during a gradient averaging operation (e.g., gradient averaging 154A) performed at node A 102A. In some embodiments, the centralized job-controller 138 may continuously or periodically receive monitoring data from respective node-level agents (e.g., node-level agent 104A) and corresponding process-level agents (e.g., process-level agent 112A) deployed within execution environments (e.g., execution environment 1 (pod) 110). In some embodiments, such monitoring data may comprise health indicators such as heartbeat signals, error logs, computational throughput metrics, and/or communication status signals indicative of the operational state of training processes.

In some embodiments, in response to detecting that the fault has occurred during the first phase, the centralized job-controller 138 may send 204, from a selected nodes of a node cluster 106 that remain healthy to a standby node, a current optimizer state and current weights for a given generative machine learning model. For example, upon analysis of such monitoring data, the centralized job-controller 138 may detect anomalies such as interruption of heartbeat signals, unexpected error messages, communication failures, or an absence of expected gradient averaging data being provided by a specific training process, such as training process (global rank 1) 114. The centralized job-controller 138 may detect that gradient averaging operation 154A performed by training process (global rank 1) 114 on node A 102A has ceased unexpectedly or failed to communicate necessary gradient data to peer nodes within the cluster 106 and may send a current optimizer state and current model weight from execution environment 2 120 at node B 102B to an execution environment 3 130 at standby node C 102C. In some embodiments, upon detection of this fault during the first phase, the centralized job-controller 138 may initiate targeted fault recovery procedures, which may involve restarting the first phase operations (e.g., forward pass, backward pass, and gradient averaging) across all healthy nodes, as further discussed in FIG. 2B.

In some embodiments, when a fault occurs during the first phase of a cycle of a training loop, such as during gradient averaging, the current optimizer state and current model weights maintained by the healthy nodes of the generative machine learning model training system 100 may not yet reflect or incorporate the effects of gradients computed by the faulty node. In some embodiments, such situation may arise during the first phase (which comprises the forward pass, backward pass, and gradient averaging operations), wherein the optimizer state updates and model weights updates have not yet occurred (as such updates may be performed subsequently during the second phase). For example, if training process (global rank 1) 114 executing at execution environment 1 (pod) 110 on node A 102A fails specifically during the gradient averaging operation (e.g., gradient averaging 154A), then the faulty node may not successfully contribute its locally computed gradients to the averaging operation. In some embodiments, as a result, the averaged gradients calculated across the healthy nodes (e.g., node B 102B) may exclude the gradients computed by the failed node. Furthermore, since optimizer state updates and model weight updates have not yet commenced at this stage of the cycle, the current optimizer state and current model weights maintained by the healthy nodes may remain identical to their states at the completion of the prior cycle and would not reflect any partial or incomplete gradient computations performed by the faulty node.

FIG. 2B illustrates a more detailed view of a generative machine learning model training system that, in response to detecting that the other fault has occurred during a first phase, restarts the first phase on healthy nodes, according to some embodiments.

In some embodiments, upon detecting a fault during the first phase of a training loop cycle (such as during gradient averaging 154A at node A 102A) the centralized job-controller 138 of the generative machine learning model training system 100 may initiate checkpoint-less recovery 206 at a standby node (e.g., node C 102C). In some embodiments, the centralized job-controller 138 may select a healthy node, such as node B 102B, to transfer a current optimizer state and current model weights to node C 102C. In some embodiments, this recovery mechanism may involve efficiently transmitting the current optimizer state and current model weights from node B 102B to node C 102C using high-performance communication channels, and initializing execution environment 3 (e.g., pod) 130 at node C 102C without loading external checkpoints. In some embodiments, subsequent to initializing the standby node (e.g., node C 102C) with the transferred states, the centralized job-controller 138 may restart the first phase of the affected cycle of the training loop (e.g., cycle A′ 251A), on the standby node. In some embodiments, the centralized job-controller 138 may restart 208 the first phase of the cycle on the other standby node. In some embodiments, restarted cycle A′ 251A at node C 102C may comprise re-performing the forward pass 152A, backward pass 153A, and gradient averaging 154A operations on the same input data batch previously handled by the faulty node (node A 102A).

In some embodiments, in response to the detected fault during the first phase at node A 102A, the centralized job-controller 138 may additionally restart 210 the first phase operations of cycle A′ 251A on remaining healthy nodes without restarting the training processes, such as node B 102B, thereby re-running forward pass 152B, backward pass 153B, and gradient averaging 154B on node B 102B without terminating the healthy training process. For example, following detection of a failure within a training process, an in-process restart may be performed using a restart code block (RCB) to recover training without terminating the process. Upon capturing an exception indicating a process-level fault within training process (global rank 3) 124 executing in execution environment 2 (pod) 120, the generative machine learning model training system 100 may initiate an in-process restart by re-executing the minimal set of code defined by the RCB. In some embodiments, this RCB may minimally include only operations that are essential for training, such as initialization of distributed process groups and communicators, recovery and synchronization of the current model and optimizer states, and resumption of the interrupted training loop cycle. In some embodiments, such coordinated restart at node B 102B without termination of the process and restart at recovered node C 102C may ensure consistency of gradient calculations and averaging across the entire cluster. In some embodiments, by performing the synchronized restart on both the standby node (node C 102C) and healthy nodes (node B 102B), the centralized job-controller 138 may recover from the fault without external checkpoints.

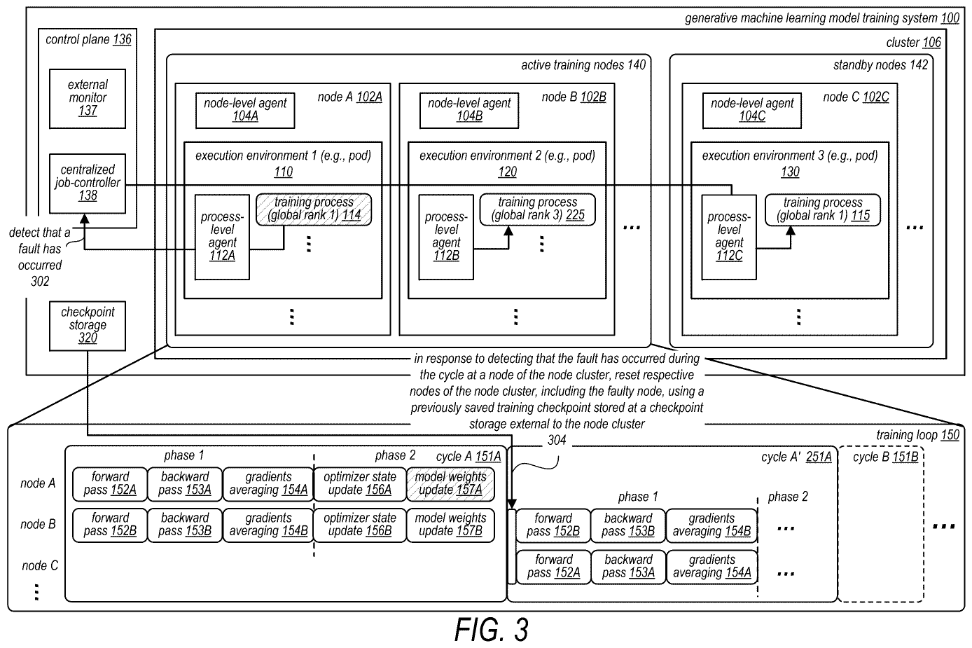

FIG. 3 illustrates a more detailed view of a generative machine learning model training system that, in response to detecting that a fault has occurred during a cycle at a node of a node cluster, reset respective nodes of the node cluster, including a faulty node, using a previously saved training checkpoint, according to some embodiments.

In some embodiments, a centralized job-controller 138 of a generative machine learning model training system 100 may detect 302 that a fault has occurred during either the first or second phase of a cycle within a training loop executed by the node cluster 106. For example, the centralized job-controller 138 may detect that a training process (global rank 1) 114 executing within execution environment 1 (e.g., pod) 110 at node A 102A is faulty during the second phase, such as at the model weights update 157A. In some embodiments, the detection of such fault may be facilitated by monitoring signals or data received from node-level agents (e.g., node-level agent 104A) or process-level agents (e.g., process-level agent 112A), including heartbeat disruptions, resource utilization anomalies, explicit error logs, or the absence of expected progress indicators. In some embodiments, in response to detecting that the fault has occurred during the cycle at a node of the node cluster, the centralized job-controller 138 may reset respective nodes of the node cluster, including the faulty node, using a previously saved training checkpoint stored at a checkpoint storage external to the node cluster. For example, in response to detecting such a fault during the training loop cycle at node A 102A, the centralized job-controller 138 may initiate a recovery mechanism utilizing a previously saved training checkpoint. In some embodiments, the centralized job-controller 138 may reset respective nodes within the node cluster 106, including the faulty node (node A 102A), to a consistent state using the training checkpoint stored in a checkpoint storage 320 external to the node cluster 106. In some embodiments, the centralized job-controller 138 may instruct the affected nodes, including node A 102A and potentially healthy nodes (such as node B 102B), to reload the optimizer states and model weights from the externally stored checkpoint to re-establish synchronization within the node cluster 106.

In some embodiments, the checkpoint storage 320 may comprise a dedicated external storage service or repository configured to persistently store training checkpoints generated at predefined intervals or milestones during the generative machine learning model training process. In some embodiments, checkpoint storage 320 may be implemented using distributed or cloud-based storage systems capable of storing large-scale model data, including model weights, optimizer states, and metadata (e.g., training epoch, iteration number, and learning rates). In some embodiments, checkpoint storage 320 may provide centralized, reliable access to previously saved checkpoints and serve as a fallback recovery mechanism in scenarios where checkpoint-less recovery strategies may not be feasible or desirable.

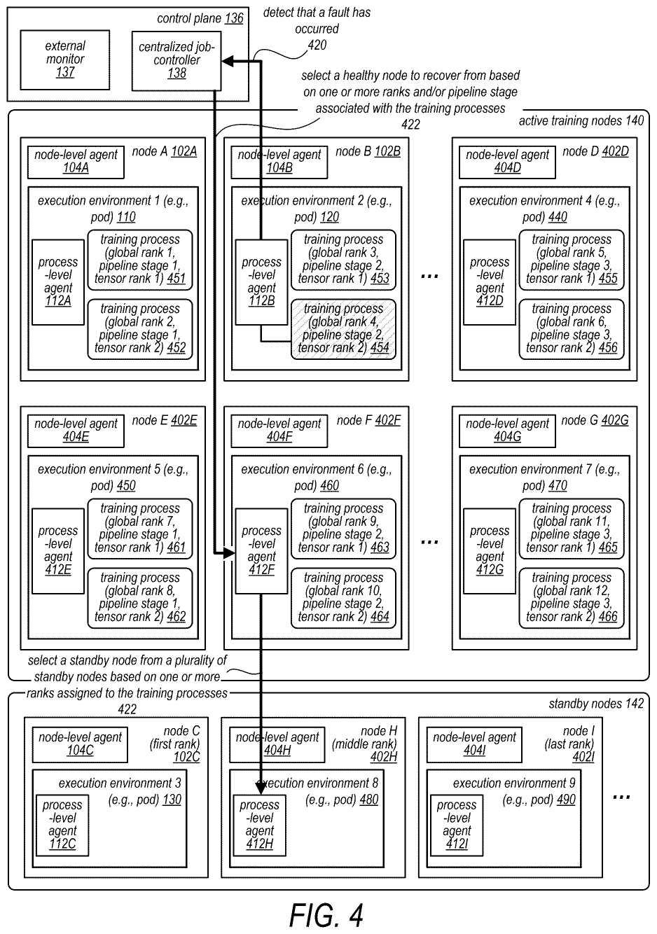

FIG. 4 illustrates a more detailed view of a generative machine learning model training system that generates, using respective process-level agents at the cluster of nodes, process-level heartbeats, wherein the respective process-level agents generate the process-level heartbeats at a heartbeat frequency, according to some embodiments.

In some embodiments, a generative machine learning model training system 100 may comprise a node cluster 106 configured to perform distributed training of generative machine learning models utilizing one or more model parallelism configurations. In some embodiments, the node cluster 106 may implement three-dimensional parallelism, which may combine data parallelism with pipeline parallelism and/or tensor parallelism. In some embodiments, such a configuration may allow the generative machine learning model training system 100 to efficiently train very large-scale generative machine learning models by distributing the model components, computation, and data across multiple nodes. For example, in some embodiments, active training nodes 140 within the node cluster 106 may comprise nodes organized according to distinct pipeline parallelism stages and tensor parallelism ranks. For example, node A 102A may comprise a node-level agent 104A and an execution environment 1 (e.g., pod) 110, which may further comprise a process-level agent 112A managing specific training processes assigned global ranks and tensor ranks within pipeline stage 1. Specifically, execution environment 1 (110) at node A 102A may include training process (global rank 1, pipeline stage 1, tensor rank 1) 451 and training process (global rank 2, pipeline stage 1, tensor rank 2) 452. Similarly, node B 102B may comprise a node-level agent 104B and execution environment 2 (e.g., pod) 120, which may comprise training process (global rank 3, pipeline stage 2, tensor rank 1) 453 and training process (global rank 4, pipeline stage 2, tensor rank 2) 454. In some embodiments, additional active training nodes within the node cluster 106 may similarly be configured to participate in parallelized model training processes. For example, node D 402D may comprise a node-level agent 404D and an execution environment 4 (440), including a process-level agent 412D, along with training processes such as training process (global rank 5, pipeline stage 3, tensor rank 1) 455 and training process (global rank 6, pipeline stage 3, tensor rank 2) 456.

Furthermore, node E 402E may comprise a node-level agent 404E and execution environment 5 (450), including a process-level agent 412E, which may execute training process (global rank 7, pipeline stage 1, tensor rank 1) 461 and training process (global rank 8, pipeline stage 1, tensor rank 2) 462. In some embodiments, the node cluster 106 may also include node F 402F, which may comprise a node-level agent 404F and execution environment 6 (460), including a process-level agent 412F, executing training process (global rank 9, pipeline stage 2, tensor rank 1) 463 and training process (global rank 10, pipeline stage 2, tensor rank 2) 464. Similarly, node G 402G may comprise a node-level agent 404G and execution environment 7 (470), including a process-level agent 412G, executing training process (global rank 11, pipeline stage 3, tensor rank 1) 465 and training process (global rank 12, pipeline stage 3, tensor rank 2) 466. In some embodiments, checkpoint-less recovery may be performed at structured organization combining data parallelism (nodes A, B, and D parallelizing with nodes E, F, and G respectively) with pipeline parallelism (with pipeline stages 1, 2, and 3 distributed across nodes) and/or tensor parallelism (multiple tensor ranks per node). For example, in some embodiments, the centralized job-controller 138 of the generative machine learning model training system 100 may detect 420 that a fault has occurred through monitoring data received from respective node-level agents and process-level agents deployed within the execution environments of the node cluster 106. In some embodiments, upon detecting the occurrence of a fault, the centralized job-controller 138 may select 422 a suitable healthy node within the node cluster 106 from which to recover model and optimizer states, based on criteria such as the global rank, pipeline parallelism stage, and/or tensor parallelism rank associated with the faulty training processes. In some embodiments, such rank-based selection ensures compatibility and consistency of transferred optimizer states and/or model weights. For example, if training process (global rank 4, pipeline stage 2, tensor rank 2) 453 on node B 102B becomes faulty, the centralized job-controller 138 may select a healthy node that has a training process with a matching pipeline parallelism stage (pipeline stage 2) and matching tensor parallelism rank (tensor rank 1), such as training process (global rank 10, pipeline stage 2, tensor rank 2) 464 executing within execution environment 6 (460) at node F 402F.

In some embodiments, the generative machine learning model training system 100 may comprise standby nodes 142 that are pre-provisioned to respond to faults occurring within the node cluster 106. In some embodiments, standby nodes 142 may be structured to align with distinct ranks associated with pipeline parallelism of the generative machine learning model being trained. For example, in some embodiments, standby nodes 142 may specifically comprise node C 102C, configured to serve as a standby node corresponding to the first pipeline parallelism rank. In some embodiments, node C 102C may comprise a node-level agent 104C and an execution environment 3 (e.g., pod) 130, which may further comprise a process-level agent 112C. In some embodiments, standby node C 102C may be pre-initialized with model partitions, optimizer states, and tensor configurations uniquely corresponding to the first parallelism rank for faster integration into the node cluster 106 upon occurrence of faults involving the first stage. In some embodiments, standby nodes 142 may further comprise node H 402H, designated as a standby node for a middle pipeline parallel rank. In some embodiments, node H 402H may include a node-level agent 404H and execution environment 8 (e.g., pod) 480, which may further comprise a process-level agent 412H. In some embodiments, standby node H 402H may be pre-configured with model components and optimizer states representative of middle parallelism rank, wherein the middle typically holding replicated model partitions that are structurally similar to the middle ranks, enabling prompt recovery in cases where faults occur at intermediate stages. In some embodiments, standby nodes 142 may additionally comprise node I 402I, assigned specifically as a standby node for the last parallelism rank. In some embodiments, node I 402I may comprise a node-level agent 404I and execution environment 9 (e.g., pod) 490, which may further include a process-level agent 412I. In some embodiments, standby node I 402I may be pre-initialized with unique model partitions, tensor sharding patterns, and optimizer states specifically associated with the last pipeline parallel rank. In some embodiments, by selecting appropriate standby nodes such as node C (first rank), node H (middle rank), and node I (last rank), the generative machine learning model training system 100 may reduce fault recovery latency across complex pipeline and tensor parallelism configurations within the distributed node cluster 106.

For example, in some embodiments, upon detecting a fault occurring at a particular node within the node cluster 106, the centralized job-controller 138 of the generative machine learning model training system 100 may select 422 a standby node from a plurality of standby nodes based on one or more ranks assigned to the training processes. In some embodiments, such rank-based selection may ensure that the chosen standby node possesses model partitions, optimizer states, and tensor configurations structurally compatible with the faulty node, for more efficient checkpoint-less recovery. For example, given that a fault occurs in a training process associated with a middle pipeline parallelism rank (e.g., training process (global rank 4, pipeline stage 2, tensor rank 2) 454), the centralized job-controller 138 may specifically select a standby node pre-initialized with model partitions and optimizer states corresponding to this middle rank. In such a scenario, the centralized job-controller 138 may select node H (middle rank) 402H from the available standby nodes, as node H 402H may already have an execution environment 8 (e.g., pod) 480 and a corresponding process-level agent 412H configured with the necessary middle-stage pipeline parallelism states and tensor configurations. In some embodiments, following selection of the standby node H 402H, the centralized job-controller 138 may coordinate transfer of relevant model weights and optimizer states from a compatible healthy node within the node cluster 106, aligned by pipeline parallelism and tensor parallelism ranks, to synchronize and rehydrate the standby node H 402H.

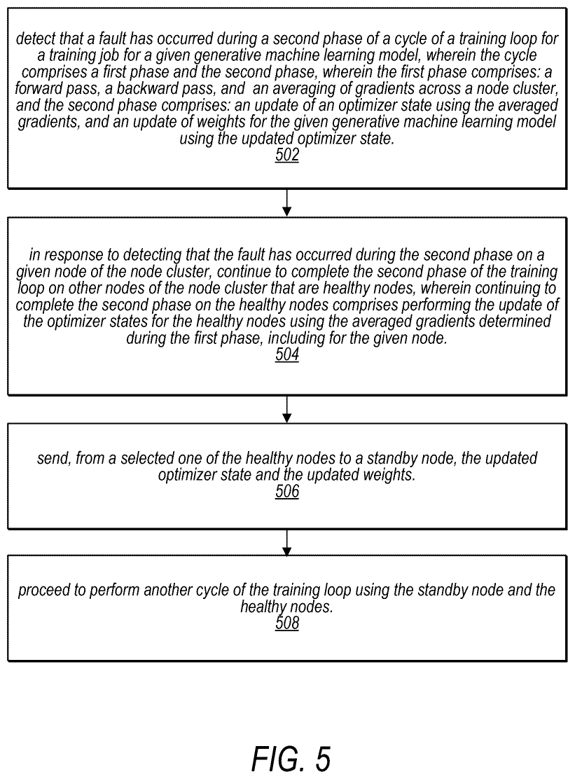

FIG. 5 illustrates a flowchart of operations that sends, from a selected one of healthy nodes to a standby node, an updated optimizer state and updated model weights, according to some embodiments.

At block 502, detect that a fault has occurred during a second phase of a cycle of a training loop executed as part of a training job for a given generative machine learning model. In some embodiments, each cycle of the training loop may comprise at least two distinct phases, including a first phase and a second phase. The first phase may include performing a forward pass, a backward pass, and an averaging of gradients across nodes within the node cluster. The second phase may include updating optimizer states using the averaged gradients and subsequently updating the weights of the given generative machine learning model based on these updated optimizer states, as further discussed in FIG. 1A.

At block 504, in response to detecting that the fault has occurred specifically during the second phase on a given node within the node cluster, continue to complete the second phase of the training loop on other nodes within the node cluster that remain healthy nodes. In some embodiments, continuing to complete the second phase on these healthy nodes may comprise performing the update of optimizer states using the averaged gradients determined during the previously completed first phase. In some embodiments, these averaged gradients may include gradients determined during the first phase by the faulty node prior to the occurrence of the fault, as further discussed in FIG. 1A.

At block 506, in response to completing the second phase on the healthy nodes, send the updated optimizer state and the updated model weights from a selected healthy node within the cluster to a standby node. In some embodiments, the selected healthy node may be chosen based on compatibility criteria, such as global rank, pipeline stage, and/or tensor parallel rank associated with the faulty node, as further discussed in FIG. 4.

At block 508, proceed to perform another cycle of the training loop, including the standby node in coordination with the previously healthy nodes. In some embodiments, the standby node, having received the updated optimizer state and updated model weights, may participate in performing a next one of forward pass, backward pass, gradient averaging, optimizer state updates, and model weight updates as part of subsequent training loop cycles, as further discussed in FIG. 1B.

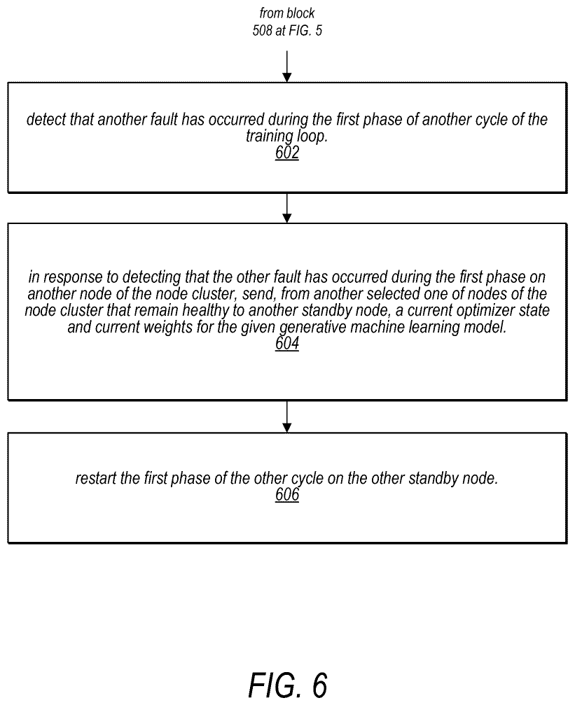

FIG. 6 illustrates a flowchart of operations performed by a generative machine learning model training system to send, in response to detecting that another fault has occurred during a first phase on another node of a node cluster, a current optimizer state and current weights for a given generative machine learning model to a standby node, according to some embodiments.

At block 602, detect that another fault has occurred during the first phase of another cycle of the training loop executed as part of a training job for a given generative machine learning model. In some embodiments, the detection of the fault may be facilitated by monitoring data received from process-level agents deployed within execution environments at nodes of the node cluster. The detected fault may occur during operations such as a forward pass, backward pass, or gradient averaging performed by the affected node, as further discussed in FIG. 2A.

At block 604, in response to detecting that the other fault has occurred specifically during the first phase on another node within the node cluster, send a current optimizer state and current weights from another selected healthy node within the node cluster to a pre-provisioned standby node. In some embodiments, the selected healthy node may be identified based on compatibility criteria, including matching pipeline parallelism ranks, tensor parallelism ranks, or model partitions, as further discussed in FIG. 4.

At block 606, restart the first phase of the affected training loop cycle on the synchronized standby node. In some embodiments, restarting the first phase may involve independently re-performing operations such as the forward pass, backward pass, and gradient averaging using the transferred optimizer state and weights, as further discussed in FIG. 2B.

### Example Computer System

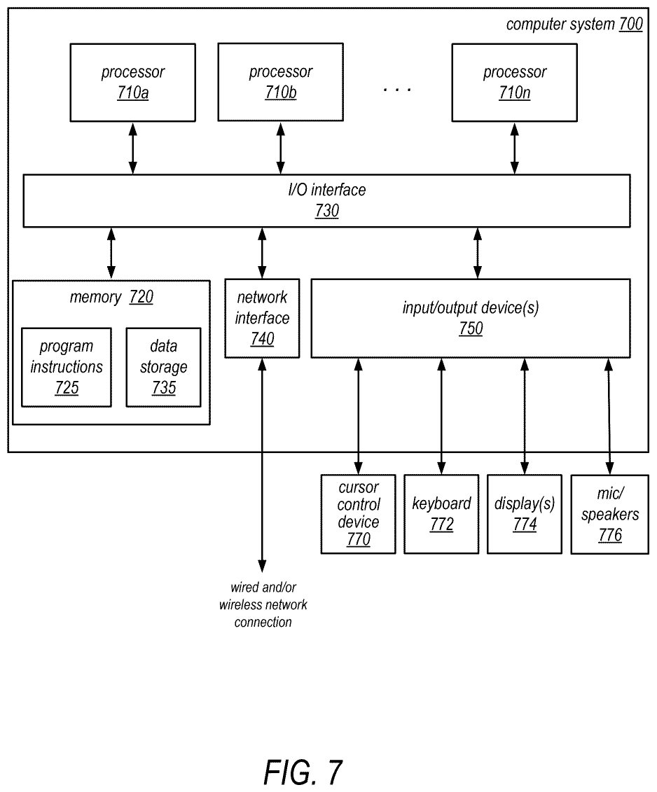

Any of various computer systems may be configured to implement processes associated with a generative machine learning model training system or any other component of the above figures. For example, FIG. 7 illustrates a block diagram illustrating an example computer system that implements some, or all, of the techniques described herein, according to some embodiments. In various embodiments, any component of the above figures, FIGS. 1A-6, may each include one or more computer systems 700 such as that illustrated in FIG. 7.

In the illustrated embodiment, computer system 700 includes one or more processors 710 coupled to a system memory 720 via an input/output (I/O) interface 730. Computer system 700 further includes a network interface 740 coupled to I/O interface 730. In some embodiments, computer system 700 may be illustrative of servers implementing enterprise logic or that provide a downloadable application, while in other embodiments servers may include more, fewer, or different elements than computer system 700.

In various embodiments, computing device 700 may be a uniprocessor system including one processor or a multiprocessor system including several processors 710a-710n (e.g., two, four, eight, or another suitable number). Processors 710a-710n may include any suitable processors capable of executing instructions. For example, in various embodiments, processors 710a-710n may be processors implementing any of a variety of instruction set formats (ISAs), such as the x77, PowerPC, SPARC, or MIPS ISAs, or any other suitable ISA. In some embodiments, processors 710a-710n may include specialized processors such as graphics processing units (GPUs), application specific integrated circuits (ASICs), etc. In multiprocessor systems, each of processors 710a-710n may commonly, but not necessarily, implement the same ISA.

System memory 720 may be configured to store program instructions and data accessible by processor(s) 710a-710n. In various embodiments, system memory 720 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 720 as code (e.g., program instructions) 725 and data storage 735.

In one embodiment, I/O interface 730 may be configured to coordinate I/O traffic between processors 710a-710n, system memory 720, and any peripheral devices in the device, including network interface 740 or other peripheral interfaces. In some embodiments, I/O interface 730 may perform any necessary protocol, timing, or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, I/O interface 730 may include support for devices attached via an automotive may bus, etc. In some embodiments, the function of I/O interface 730 may be split into two or more separate components, such as a north bridge and a south bridge, for example. Also, in some embodiments, some, or all of the functionality of I/O interface 730, such as an interface to system memory 720, may be incorporated directly into processors 710a-710n.

In some embodiments, the network interface 740 may be coupled to I/O interface 730, and one or more input/output devices 750, such as cursor control device 770, keyboard 772, display(s) 774, and microphone/speakers 776. In some cases, it is contemplated that embodiments may be implemented using a single instance of computer system 700, while in other embodiments multiple such computer systems, or multiple nodes making up computer system 700, may be configured to host different portions or instances program instructions as described above for various embodiments. For example, in one embodiment some elements of the program instructions may be implemented via one or more nodes of computer system 700 that are distinct from those nodes implementing other elements.

Network interface 740 may be configured to allow data to be exchanged between computing device 700 and other devices associated with a network or networks. In various embodiments, network interface 740 may support communication via any suitable wired or wireless general data networks, such as types of ethernet networks, cellular networks, Bluetooth networks, Wi-Fi networks, Ultra-wideband Networks, for example. Additionally, network interface 740 may support communication via telecommunications/telephony networks such as analog voice networks or digital fiber communications networks, via storage area networks such as Fibre Channel SANs, or via any other suitable type of network and/or protocol.

In some embodiments, system memory 720 may be one embodiment of a computer-readable (e.g., computer-accessible) medium configured to store program instructions and data as described above for implementing embodiments of the corresponding methods, systems, and apparatus. However, in other embodiments, program instructions and/or data may be received, sent, or stored upon different types of computer-readable media. Generally speaking, a computer-readable medium may include non-transitory storage media or memory media such as magnetic or optical media, e.g., disk or DVD/CD coupled to computing device 700 via I/O interface 730. One or more non-transitory computer-readable storage media may also include any volatile or non-volatile media such as RAM (e.g., SDRAM, DDR SDRAM, RDRAM, SRAM, etc.), ROM, etc., that may be included in some embodiments, of computing device 700 as system memory 720 or another type of memory. Further, a computer-readable medium may include transmission media or signals such as electrical, electromagnetic, or digital signals, conveyed via a communication medium such as a network and/or a wireless link, such as may be implemented via network interface 740. Portions or all of multiple computing devices such as that illustrated in FIG. 7 may be used to implement the described functionality in various embodiments; for example, software components running on a variety of different devices and servers may collaborate to provide the functionality. In some embodiments, portions of the described functionality may be implemented using storage devices, network devices, or various types of computer systems. The term “computing device” and “ECU” as used herein, refers to at least all these types of devices, and is not limited to these types of devices.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein (e.g., the functionality of various services, databases, devices, and/or other communication devices, etc.).

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending, or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

1. A system, comprising:
one or more computing devices configured to:
train, using a node cluster managed by a generative machine learning model training system, a given generative machine learning model with a training job, wherein the node cluster perform training processes of the training job;
detect a fault for one or more training processes performed on a given node of the node cluster;
determine whether the fault has occurred during a first phase or a second phase of a cycle of a training loop for the training job, wherein the cycle comprises
the first phase and the second phase, and wherein the first phase comprises:
a forward pass,
a backward pass, and
an averaging of gradients across the node cluster, and
the second phase comprises:
an update of an optimizer state using the averaged gradients, and
an update of weights for the given generative machine learning model using the updated optimizer state;
in response to a determination that the fault has occurred during the second phase on the given node, continue to complete the second phase of the training loop on other nodes of the node cluster that are healthy nodes,
wherein to continue to complete the second phase on the healthy nodes, the one or more computing devices are configured to:
perform the update of the optimizer states for the healthy nodes using the averaged gradients determined during the first phase, including for the given node; and
send, from a selected one of the healthy nodes to a standby node, the updated optimizer state and the updated weights.

2. The system of claim 1, wherein the one or more computing devices are further configured to:
detect that another fault has occurred during the first phase of another cycle of the training loop;
in response to detecting that the other fault has occurred during the first phase on another node of the node cluster, send, from another selected one of nodes of the node cluster that remain healthy to another standby node, a current optimizer state and current weights for the given generative machine learning model; and
restart the first phase of the other cycle on the other standby node.

3. The system of claim 2, wherein the one or more computing devices are further configured to:
in response to detecting that the other fault has occurred during the first phase on the other node of the node cluster, restart the first phase of the other cycle on the nodes of the node cluster that remain healthy.

4. The system of claim 1, wherein the one or more computing devices are further configured to:
proceed to perform another cycle of the training loop using the standby node and the healthy nodes, wherein the other cycle is performed at the healthy-nodes without a process-level restart, and wherein the other cycle is performed at the standby node without using an external checkpoint.

5. The system of claim 1, wherein the one or more computing devices are further configured to:
detect that another fault has occurred during another cycle of the training loop; and
in response to detecting that the other fault has occurred during the other cycle at another node of the node cluster, reset respective nodes of the node cluster, including the other node, using a previously saved training checkpoint stored at a checkpoint storage external to the node cluster.

6. The system of claim 1, wherein the selected one of the healthy nodes is a data parallel peer, and wherein the selection is based on the selected one of the healthy nodes having one or more of:
a same one or more layers of the given generative machine learning model for the given node, or
a same one or more tensors of the given generative machine learning model for the given node.

7. The system of claim 1, wherein the one or more computing devices are further configured to:
select the standby node from a plurality of standby nodes based on one or more ranks assigned to one or more training processes of the training job performed on the given node, wherein the plurality of standby nodes comprise:
a standby node for a first rank,
a standby node for a last rank, and
a standby node for a middle rank in between the first rank and the last rank.

8. A method, comprising:
detecting that a fault has occurred during a second phase of a cycle of a training loop for a training job for a given generative machine learning model, wherein the cycle comprises a first phase and the second phase, wherein the first phase comprises:
a forward pass,
a backward pass, and
an averaging of gradients across a node cluster, and
the second phase comprises:
an update of an optimizer state using the averaged gradients, and
an update of weights for the given generative machine learning model using the updated optimizer state;
in response to detecting that the fault has occurred during the second phase on a given node of the node cluster, continuing to complete the second phase of the training loop on other nodes of the node cluster that are healthy nodes,
wherein continuing to complete the second phase on the healthy nodes comprises:
performing the update of the optimizer states for the healthy nodes using the averaged gradients determined during the first phase, including for the given node; and
sending, from a selected one of the healthy nodes to a standby node, the updated optimizer state and the updated weights.

9. The method of claim 8, further comprising:
detecting that another fault has occurred during the first phase of another cycle of the training loop;
in response to detecting that the other fault has occurred during the first phase on another node of the node cluster, sending, from another selected one of nodes of the node cluster that remain healthy to another standby node, a current optimizer state and current weights for the given generative machine learning model; and
restarting the first phase of the other cycle on the other standby node.

10. The method of claim 9, further comprising:
in response to detecting that the other fault has occurred during the first phase on the other node of the node cluster, restarting the first phase of the other cycle on the nodes of the node cluster that remain healthy.

11. The method of claim 8, further comprising:
proceeding to perform another cycle of the training loop using the standby node and the healthy nodes, wherein the other cycle is performed at the healthy-nodes without a process-level restart.

12. The method of claim 8, further comprising:
proceeding to perform another cycle of the training loop using the standby node and the healthy nodes, wherein the other cycle is performed at the standby node without using an external checkpoint.

13. The method of claim 8, further comprising:
detecting that another fault has occurred during another cycle of the training loop; and
in response to detecting that the other fault has occurred during the other cycle at another node of the node cluster, resetting respective nodes of the node cluster, including the other node, using a previously saved training checkpoint stored at a checkpoint storage external to the node cluster.

14. The method of claim 8, wherein the selected one of the healthy nodes is a data parallel peer, and wherein the selection is based on the selected one of the healthy nodes having one or more of:
a same one or more layers of the given generative machine learning model for the given node, or
a same one or more tensors of the given generative machine learning model for the given node.

15. The method of claim 8, further comprising:
selecting the standby node from a plurality of standby nodes based on one or more ranks assigned to one or more training processes of the training job performed on the given node, wherein the plurality of standby nodes comprise:
a standby node for a first rank,
a standby node for a last rank, and
a standby node for a middle rank in between the first rank and the last rank.

16. One or more non-transitory, computer-readable storage media storing program instructions that, when executed on or across one or more computing devices, cause the one or more computing devices to:
detect that a fault has occurred during a second phase of a cycle of a training loop for a training job for a given generative machine learning model, wherein the cycle comprises a first phase and the second phase, wherein the first phase comprises:
a forward pass,
a backward pass, and
an averaging of gradients across a node cluster, and
the second phase comprises:
an update of an optimizer state using the averaged gradients, and
an update of weights for the given generative machine learning model using the updated optimizer state;
in response to detecting that the fault has occurred during the second phase on a given node of the node cluster, continue to complete the second phase of the training loop on other nodes of the node cluster that are healthy nodes,
wherein to continue to complete the second phase on the healthy nodes, the program instructions, when executed on or across one or more computing devices, further cause the one or more computing devices to:
perform the update of the optimizer states for the healthy nodes using the averaged gradients determined during the first phase, including for the given node; and
send, from a selected one of the healthy nodes to a standby node, the updated optimizer state and the updated weights.

17. The one or more non-transitory, computer-readable, storage media of claim 15, wherein the program instructions, when executed on or across one or more computing devices, further cause the one or more computing devices to:
detect that another fault has occurred during the first phase of another cycle of the training loop;
in response to detecting that the other fault has occurred during the first phase on another node of the node cluster, send, from another selected one of nodes of the node cluster that remain healthy to another standby node, a current optimizer state and current weights for the given generative machine learning model; and
restart the first phase of the other cycle on the other standby node.

18. The one or more non-transitory, computer-readable, storage media of claim 16, wherein the program instructions, when executed on or across one or more computing devices, further cause the one or more computing devices to:
in response to detecting that the other fault has occurred during the first phase on the other node of the node cluster, restart the first phase of the other cycle on the nodes of the node cluster that remain healthy.

19. The one or more non-transitory, computer-readable, storage media of claim 15, wherein the program instructions, when executed on or across one or more computing devices, further cause the one or more computing devices to:
detect that another fault has occurred during another cycle of the training loop; and
in response to detecting that the other fault has occurred during the other cycle at another node of the node cluster, reset respective nodes of the node cluster, including the other node, using a previously saved training checkpoint stored at a checkpoint storage external to the node cluster.

20. The one or more non-transitory, computer-readable, storage media of claim 15, wherein the selected one of the healthy nodes is a data parallel peer, and wherein the selection is based on the selected one of the healthy nodes having one or more of:
a same one or more layers of the given generative machine learning model for the given node, or
a same one or more tensors of the given generative machine learning model for the given node.
